(19) United States
(12) Patent Application Publication
(10) Pub. No.: US 2008/0158428 A1
(43) Pub. Date: Jul. 3, 2008

(54) Dynamic Cross Color Elimination

(75) Inventors: Takatoshi Ishii, Sunnyvale, CA (US); Guangjun Miao, Hefei (CN)

Correspondence Address: STRATEGIC PATENT GROUP, P.C., P.O. BOX 1329, MOUNTAIN VIEW, CA, 94042, US

(73) Assignee: TVIA, INC., Santa Clara, CA (US)

(21) Appl. No.: 11/619,552

(22) Filed: Jan. 3, 2007

(51) Int. Cl. H04N 9/77

(52) U.S. Cl. 348/663; 348/E09.035

(57) ABSTRACT

A method and system for cross color elimination is disclosed in processing of a component video signal comprising component luminance and chrominance information. Aspects of the exemplary embodiments include using separated luminance and chrominance information for each pixel in a current frame, getting absolute distance values between C=a current frame pixel color, P=a previous frame pixel color, H=a high frequency color of the previous frame, and O=a center of a color space; comparing each absolute distance value with a predetermined threshold, wherein if any of the absolute distance values exceed the predetermined threshold, then the pixel is a cross color pixel; and for each cross color pixel, replacing a current frame pixel color with a high frequency average pixel color.

### BACKGROUND OF THE INVENTION

Luminance and chrominance information share a portion of the total signal bandwidth in composite video television systems, such as National Television Systems Committee (NTSC) and Phase Alternating Line (PAL). In NTSC, for example, as illustrated in FIG. 1, chrominance information is encoded on a subcarrier of 3.579545 MHz. Within the chrominance band, which extends from roughly 2.3 MHz to 4.2 MHz, both the chrominance (UV) and luminance (Y) spectra are intermixed and overlapped.

A composite decoder extracts both luminance spectral information and chrominance spectral information from the composite signal. However, if the screen has moving areas and has high frequency pattern pictures, existing decoders cannot distinguish clearly between luminance and chrominance information. As a result, these decoders generate incorrect chrominance information based upon the luminance spectrum. This misinterpretation of high-frequency luminance information as chrominance information is called “cross color”.

For example, FIG. 2A is a diagram illustrating chrominance signal behavior of a high frequency still picture. The diagram illustrates a current pixel color (C) and the previous pixel color (P) in the color space for a high frequency static picture. The high frequency chrominance color position (H) can be estimated as an average high frequency color between C and P. Since the picture does not move, the range of possible H forms a static circle and is predictable. In contrast, FIG. 2B is a diagram illustrating chrominance signal behavior of a high frequency motion picture. The diagram illustrates a current pixel color (C), first previous pixel color (P1), and second previous pixel color (P2) in the color space. Because the picture is moving, the possible range for high frequency chrominance color position (H) is difficult to anticipate, as a pixel color position can be anywhere in the UV domain.

The current trend in television display device technology is to make screens larger and brighter, which is causing cross color to become more noticeable. Thus, increased efficiency in the reduction of cross color is important.

Existing methods to eliminate cross color includes filtering of chrominance information in the decoding processes. Two dimensional and three dimensional comb filters have been used, which typically have two response characteristics. One response characteristic is for the luminance path and a second response for the chrominance path. However, this technique works well with still pictures but not moving pictures with a high frequency pattern.

Accordingly, there exists a need for a method and system for efficient dynamic cross color elimination. The invention addresses such a need.

### SUMMARY OF THE INVENTION

The exemplary embodiments provide a method and system for efficient cross color elimination in processing of a component video signal comprising component luminance and chrominance information. Aspects of the exemplary embodiments include using separated luminance and chrominance information for each pixel in a current frame, getting absolute distance values between C=a current frame pixel color, P=a previous frame pixel color, H=a high frequency color of the previous frame, and O=a center of a color space; comparing each absolute distance value with a predetermined threshold, wherein if any of the absolute distance values exceed the predetermined threshold, then the pixel is a cross color pixel; and for each cross color pixel, replacing a current frame pixel color with a high frequency average pixel color.

By processing component signals after the composite signal decoding stage, the method and system according to the invention can be used in NTSC, PAL, and any other television system. The method and system according to the invention is relevant to liquid crystal display (LCD) televisions, CRT televisions, and plasma display televisions. It is also possible to use HDTV, new and existing digital TV broadcast systems, and digital component signal broadcast TV systems with the invention. The invention is also applicable to any color differential space, not just YUV, such as YCbCr (Rec. 601), YCbCr (Rec. 709), YIQ, YDbDr, YPbPr, or any other color differential spaces.

### BRIEF DESCRIPTION OF THE FIGURES

FIG. 1 is a diagram illustrating composite video signal luminance and chrominance signal bandwidths.

FIG. 2A illustrates chrominance signal behavior of high frequency still picture.

FIG. 2B illustrates chrominance signal behavior of high frequency moving picture.

FIG. 3 is a diagram illustrating a first exemplary embodiment of a dynamic cross color elimination system.

FIG. 4 is a flowchart illustrating a first exemplary embodiment of a dynamic cross color elimination method.

FIG. 5 is a diagram illustrating a second exemplary embodiment of a dynamic cross color elimination system.

FIG. 6 is a flowchart illustrating a second exemplary embodiment of a dynamic cross color elimination method.

FIG. 7 is a diagram illustrating a third exemplary embodiment of a dynamic cross color elimination system with luminance recovery.

FIG. 8 is a flowchart illustrating a third exemplary embodiment of a dynamic cross color elimination method with luminance recovery.

FIG. 9 is a diagram illustrating a fourth exemplary embodiment of a dynamic cross color elimination system with a frame statistics dictionary.

FIG. 10 is a flowchart illustrating a fourth exemplary embodiment of a dynamic cross color elimination method with a frame statistics dictionary.

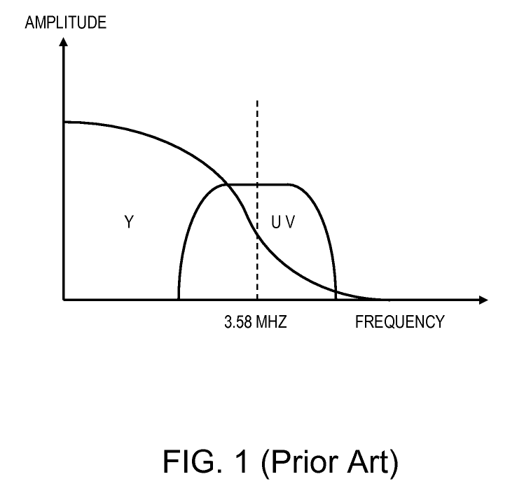

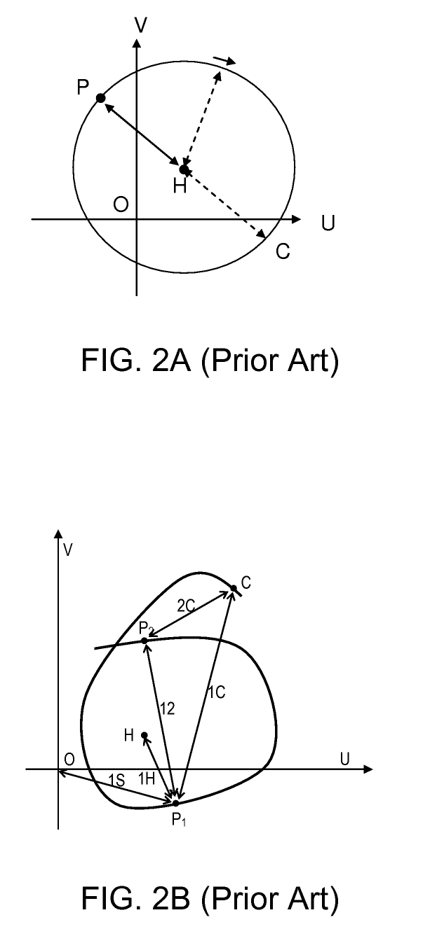

### DETAILED DESCRIPTION

The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The method and system according to the invention significantly reduces cross color artifacts from component video signals by detecting rapid changes of chrominance signals over several frames in the time domain. In one embodiment, cross color pixels are detected by comparing a threshold value with a difference between a current frame chrominance and at least one previous frame chrominance. The color data of the cross color pixels are replaced by the same location pixel color in the previous frame or by a high frequency average color. In a further embodiment, the luminance component is also recovered by calculating the difference of input and output chrominance values for delta chrominance, converting the delta chrominance to delta luminance, and adding the delta luminance to the output luminance from a component video source.

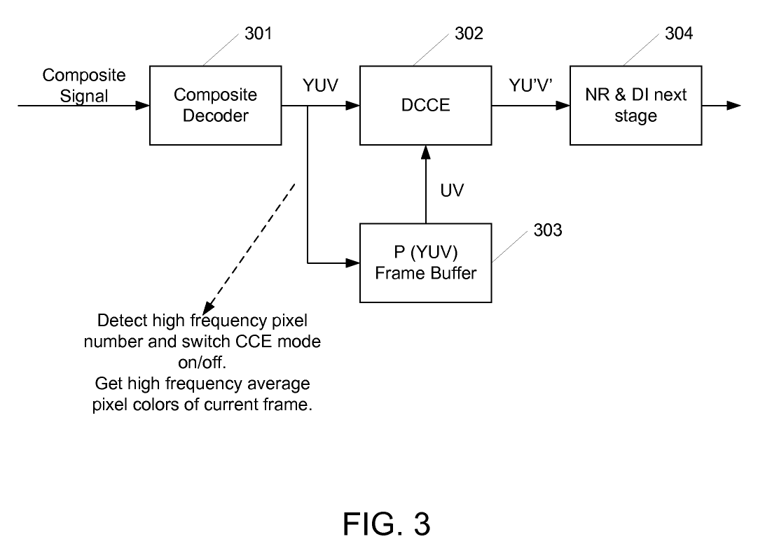

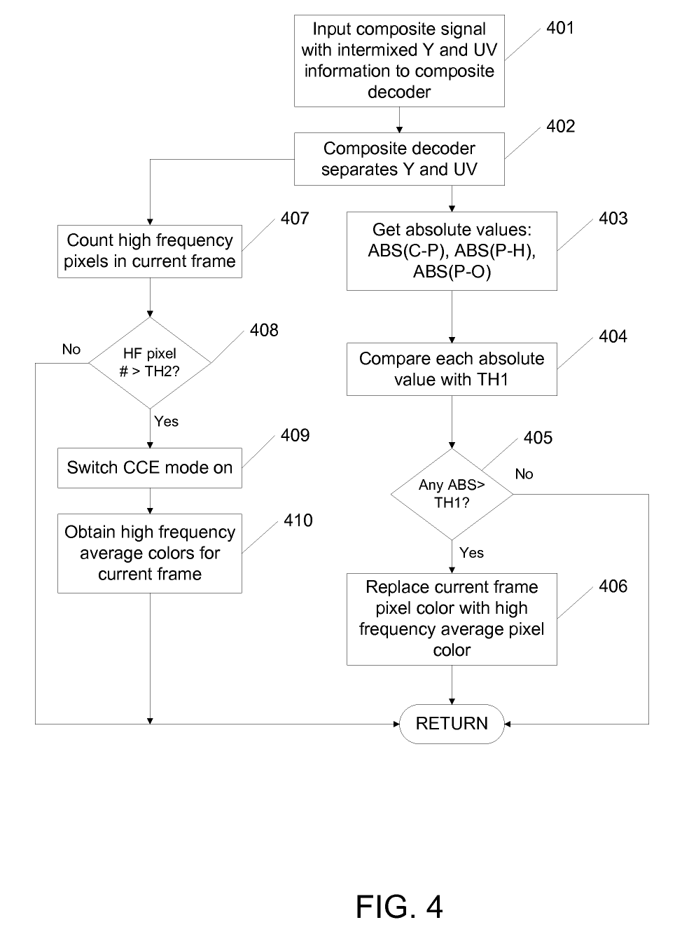

FIGS. 3 and 4 illustrate a first exemplary embodiment of a dynamic cross color elimination system and method. The system includes a composite decoder 301, a dynamic cross color elimination module (DCCE) 302, and a frame buffer 303. A composite signal with intermixed luminance (Y) and chrominance (UV) information is input into the composite decoder 301 (step 401). The composite decoder 301 separates the Y and UV (step 402). The DCCE 302 detects cross color pixels by comparing the pixels of the current frame to the pixels of the previous frame. In this embodiment, the previous frame is the frame immediately previous to the current frame. Specifically, the DCCE 302 gets the absolute values (ABS) of C−P, P−H, and P−O (step 403) for each pixel in the current frame. C is the current frame pixel color; P is the previous frame pixel color; H is the position of the high frequency pixel color of the previous frame; and O is the center of the color space. Here, P is obtained from the frame buffer 303. The DCCE 302 compares each ABS value with a predetermined threshold, TH1, (step 404). If any of them exceeds TH1 (step 405), then the pixel is a cross color pixel. The current frame pixel color is then replaced with the high frequency average pixel color (step 405). When luminance is determined to have changed quickly from pixel to pixel, the pixels in this area likely includes a high frequency component. The UV information for the pixels in this area are then captured and averaged to obtain the high frequency average pixel color. The output of the DCCE 302 is YU′V′, where U′V′ is the corrected chrominance. The corrected signal is then output to the next stage, such as a noise reduction and de-interlacing stage 304.

Performed in parallel to the DCCE steps 403-406, the number of high frequency pixels in the current frame is counted (step 407). If the high frequency pixel number exceeds a predetermined threshold, TH2, (step 408), then the DCCE 302 is switched to an “on” state (step 409). The high frequency average color for the pixels in the current frame are then determined (step 410), and stored in the register of DCCE module 302 to be used in next processing of the previous frame.

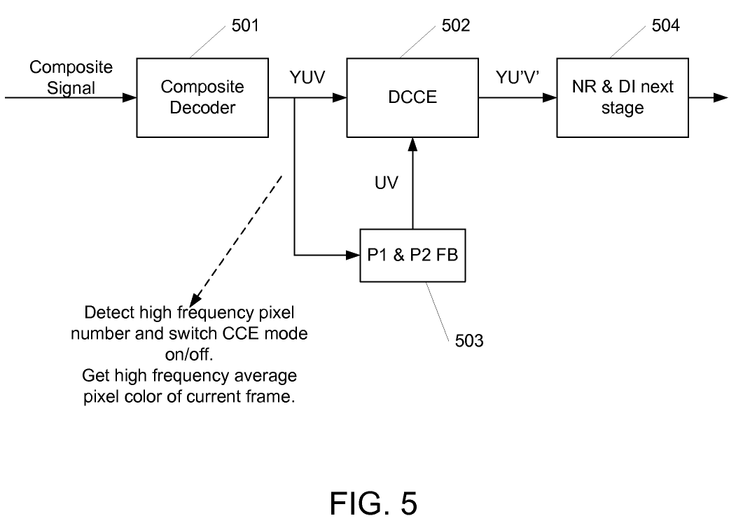

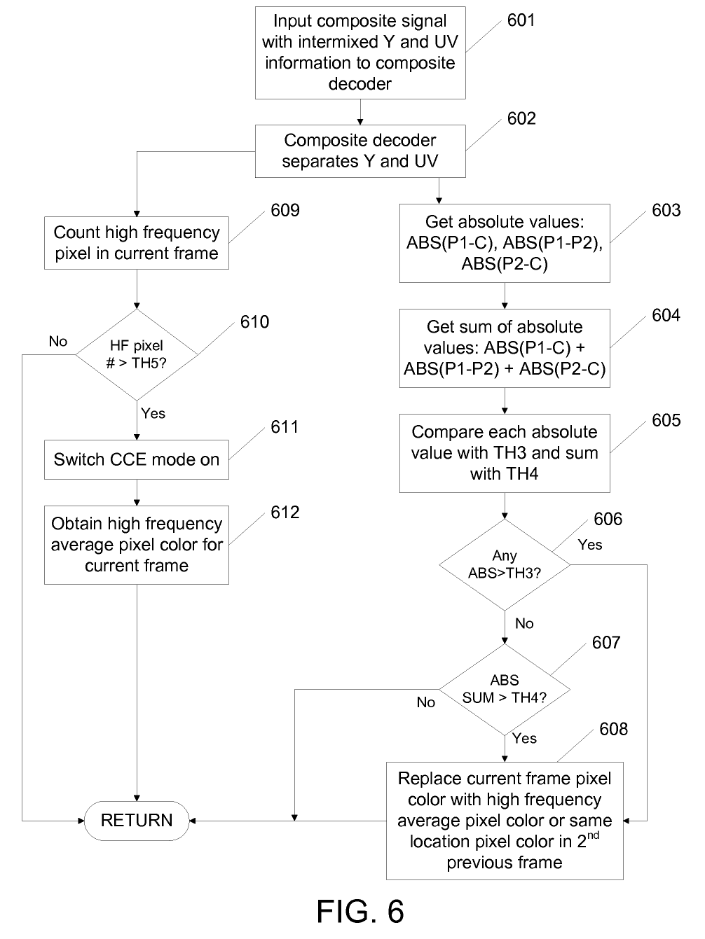

FIGS. 5 and 6 illustrate a second exemplary embodiment of a dynamic cross color elimination system and method. The system includes a composite decoder 501, a DCCE 502, and two frame buffers 503. A composite signal with intermixed luminance (Y) and chrominance (UV) information is input into the composite decoder 501 (step 601). The composite decoder 501 separates the Y and UV (step 602). The DCCE 502 detects cross color pixels by comparing the pixels of the current frame to the pixels of the first and second previous frames. In this embodiment, the first previous frame is the frame immediately previous to the current frame, and the second previous frame is the frame immediately previous to the first previous frame. Specifically, the DCCE 502 gets the absolute values (ABS) of P1−C, P1−P2, and P2−C (step 603) for each pixel. C is the current frame pixel color; P1 is the first previous frame pixel color; and P2 is the second previous pixel color. Here, P1 and P2 are obtained from the frame buffers 503. The DCCE 502 also gets the sum of the absolute values: ABS(P1−C)+ABS(P1−P2)+ABS(P2−C) (step 604). The DCCE 502 compares each ABS value with a predetermined threshold, TH3, and the sum with another predetermined threshold, TH4 (step 605). If any of the ABS values is above TH3 (step 606), or if the sum is above TH4 (step 607), then the pixel is a cross color pixel. The current frame pixel color is then replaced with the high frequency average pixel color or the color of the same location pixel of the second previous frame (step 608). The output of the DCCE 502 is YU′V′, where U′V′ is the corrected chrominance. The corrected signal is then output to the next stage, such as a noise reduction and de-interlacing stage 504.

Performed in parallel to the DCCE steps 603-608, the number of high frequency pixels in the current frame is counted (step 609). If the high frequency pixel number exceeds a predetermined threshold, TH5 (step 610), then the DCCE 502 is switched to an “on” state (step 611). The high frequency average colors for the pixels in the current frame is obtained (step 612), and stored in the register of DCCE module 502, to be used in next processing of the previous frame.

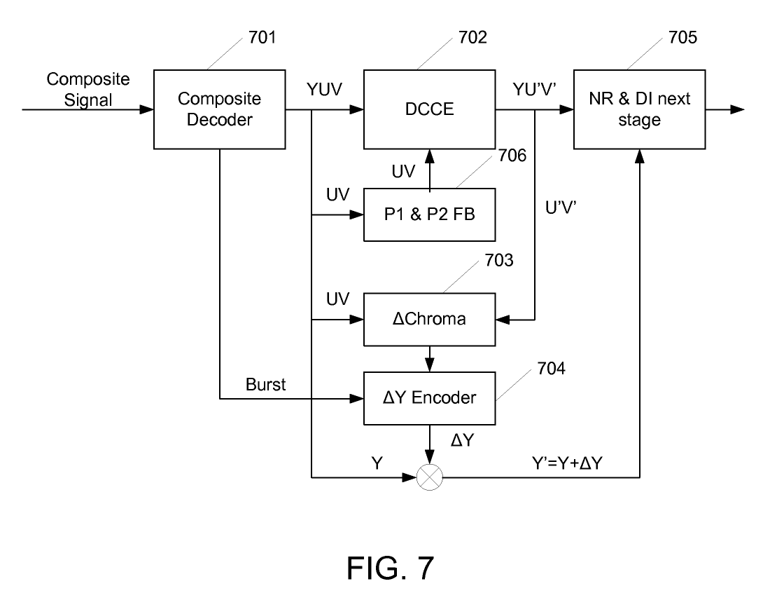

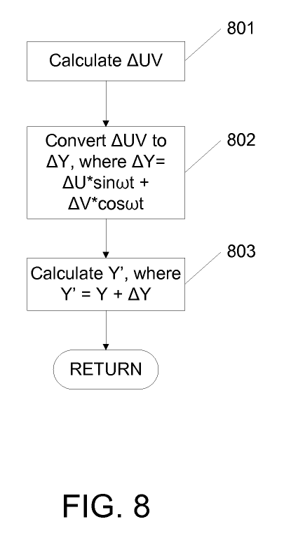

FIGS. 7 and 8 illustrate a third exemplary embodiment of a dynamic cross color elimination system and method. The composite decoder 701, the DCCE 702, and the frame buffer 706 for P1 and P2 perform cross color elimination in the same manner as described in FIGS. 3 and 4 or FIGS. 5 and 6 above. In this embodiment, the system additionally recovers the misinterpreted luminance information in the composite signal. The system includes a Δchroma module 703 and a ΔY encoder 704. The Δchroma module 703 uses the UV information output from the composite decoder 701 and the U′V′ information output from the DCCE 702 to calculate ΔU and ΔV (step 801). The ΔY encoder 704 converts the ΔUV to the ΔY (step 802) using the following algorithm:

$$\begin{matrix}composite signal = Y + U * sin ω t + V * cos ω t \\ = Y + ( {U}^{′} + Δ U ) * sin ω t + ( {V}^{′} + Δ V ) * cos ω t \\ = Y + ( Δ U ) * sin ω t + ( Δ V ) * cos ω t + \\ {U}^{′} * sin ω t + {V}^{′} * cos ω t \\ = {Y}^{′} + {U}^{′} * sin ω t + {V}^{′} * cos ω t\end{matrix}$$

where ωt=subcarrier frequency from the burst phase, and

ΔY=ΔU*sin ωt+ΔV*cos ωt.

The recovered Y (Y′) is then calculated (step 803) using the equation Y′=Y+ΔY. The signal with the corrected chrominance information and the recovered luminance information is then output to the next stage, such as a noise reduction and de-interlacing stage 705.

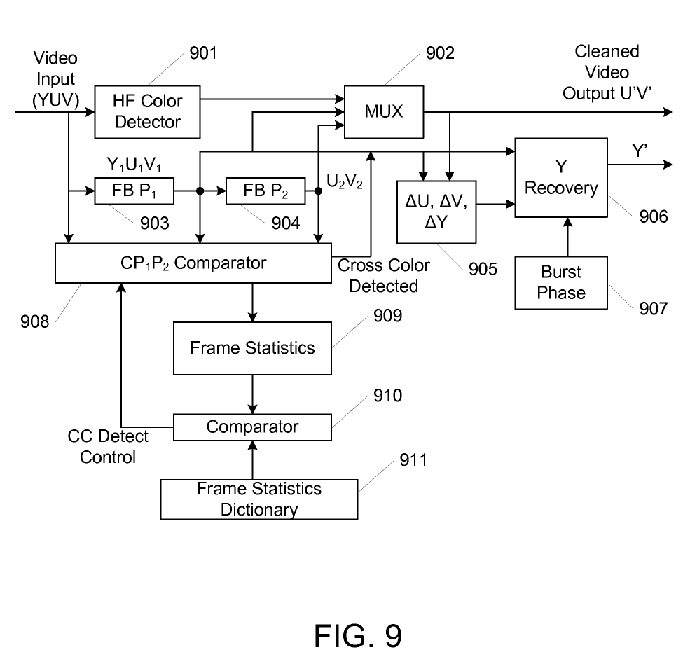

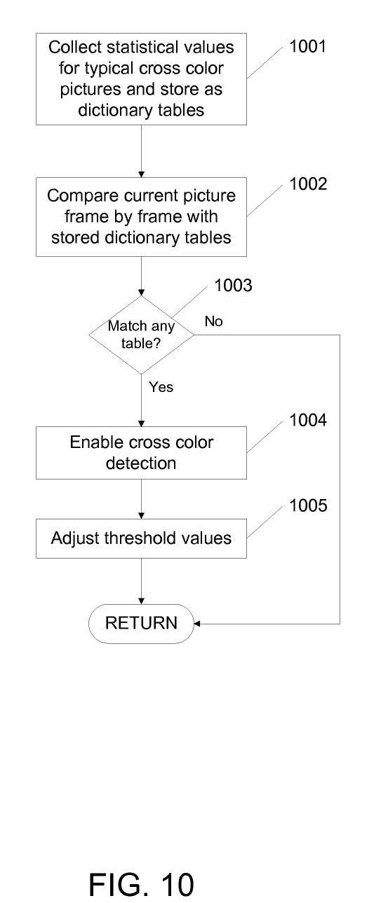

FIGS. 9 and 10 illustrate a fourth exemplary embodiment of a dynamic cross color elimination system and method. The cross color elimination is performed in the same manner as described above in FIGS. 3 and 4 or in FIGS. 5 and 6, using the high frequency color detector 901, the multiplexer 902, and the CP₁P₂ comparator 908 as part of the DCCE, and using the frame buffer 903 for the first immediate previous frame and the frame buffer 904 for the second immediate previous frame. The luminance recovery is performed in the same manner as described above in FIGS. 7 and 8, using the Δchroma module and ΔY encoder 905, the burst phase 907, and the Y recovery module 906 which calculates Y′. In some cases, however, the frame has varied motion with the high frequency pixels. Occasionally, the comparator 908 will misunderstand this as cross color. To avoid this problem, the fourth exemplary embodiment uses a frame statistics dictionary 911. As the system processes frames, statistical values for typical cross color pictures are collected by the frame statistics module 902 and stored as dictionary tables in the frame statistics dictionary 911 (step 1001). The frame statistics module 909 counts frame by frame the number of times the pixels exceed certain limit values, as set forth below, where CNT* are counter variables:

If ABS (P1−C)>Lim1C, then CNT1C=CNT1C+1

If ABS (P2−C)>Lim2C then CNT2C=CNT2C+1

If ABS (P1−P2)>Lim12 then CNT12=CNT12+1

If ABS (P1−H)>Lim1H then CNT1H=CNT1H+1

If ABS (P1−O)>Lim1S then CNT1S=CNT1S+1

When a current picture is processed, the comparator 910 compares each frame of the picture with the stored dictionary tables 911 (step 1002). If a frame matches any of the tables, then cross color is statistically likely and cross color detection is enabled (step 1004). The various threshold values, TH1 through TH5, are adjusted accordingly (step 1005).

A method and system for efficient cross color elimination have been disclosed. Cross color artifacts are significantly reduces cross color artifacts from component video signals by detecting rapid changes of chrominance signals over several frames in the time domain. In one embodiment, cross color pixels are detected by comparing a threshold value with a difference between a current frame chrominance and at least one previous frame chrominance. The color data of the cross color pixels are replaced by the same location pixel color in the previous frame or by a high frequency average color. In a further embodiment, the luminance component is also recovered by calculating the difference of input and output chrominance value for delta chrominance, converting the delta chrominance to delta luminance, and adding the delta luminance to the output luminance from a component video source. The component video source can be the output of a composite video decoder, pre-recoded component video signals, or pre-decoded video signals.

By processing component signals after the composite signal decoding stage, the method and system according to the invention can be used in NTSC, PAL, and any other television system. The method and system according to the invention is relevant to liquid crystal display (LCD) televisions, CRT televisions, and plasma display televisions. It is also possible to use HDTV, new and existing digital TV broadcast systems, and digital component signal broadcast TV systems with the invention. The invention is also applicable to any color differential space, not just YUV, such as YCbCr (Rec. 601), YCbCr (Rec. 709), YIQ, YDbDr, YPbPr, or any other color differential spaces.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for cross color elimination in processing of a component video signal comprising component luminance and chrominance information, comprising:
(a) using separated luminance and chrominance information for each pixel in a current frame, getting absolute distance values between C=a current frame pixel color, P=a previous frame pixel color, H=a high frequency color of the previous frame, and O=a center of a color space;
(b) comparing each absolute distance value with a predetermined threshold, wherein if any of the absolute distance values exceed the predetermined threshold, then the pixel is a cross color pixel; and
(c) for each cross color pixel, replacing a current frame pixel color with a high frequency average pixel color.

2. The method of claim 1, further comprising:
(d) counting high frequency pixels in the current frame;
(e) determining if a number of high frequency pixels exceeds a second predetermined threshold;
(f) if the number exceeds the second predetermined threshold, then switching a color code elimination mode to “on”; and
(g) obtaining high frequency average colors for the pixels in the current frame.

3. The method of claim 1, further comprising (d) recovering corrected luminance information, wherein the recovering (d) comprises:
(d1) calculating a Δ chrominance from the separated chrominance information and a corrected chrominance information;
(d2) converting the Δ chrominance to Δ luminance; and
(d3) calculating the corrected luminance information by summing the separated luminous information with the Δ luminance.

4. The method of claim 1, further comprising:
(d) comparing the current frame with tables in a frame statistics dictionary, wherein the tables comprise statistical values for typical cross color pictures collected during cross color elimination processing of the cross color pictures; and
(e) if the current frame matches any of the tables in the frame statistics dictionary, then enabling cross color detection and adjusting threshold values.

5. A method for cross color elimination in processing of a component video signal comprising component luminance and chrominance information, comprising:
(a) using separated luminance and chrominance information for each pixel in a current frame, getting absolute distance values between C=the current frame pixel color, P1=first previous frame pixel color, and P2=second previous frame pixel color, and
getting a sum of the absolute distance values;
(b) comparing each absolute distance value with a first predetermined threshold, and comparing the sum with a second predetermined threshold, wherein if any of the absolute distance values exceed the first predetermined threshold, or the sum exceeds the second predetermined threshold, then the pixel is a cross color pixel; and
(c) for each cross color pixel, replacing a current frame pixel color with a high frequency average pixel color or a same location pixel color of the second previous frame.

6. The method of claim 5, further comprising:
(d) counting high frequency pixels in the current frame;
(e) determining if a number of high frequency pixels exceeds a second predetermined threshold;
(f) if the number exceeds the second predetermined threshold, then switching a color code elimination mode to “on”; and
(g) obtaining high frequency average colors for the pixels in the current frame.

7. The method of claim 5, further comprising (d) recovering corrected luminance information, wherein the recovering (d) comprises:
(d1) calculating a Δ chrominance from the separated chrominance information and a corrected chrominance information;
(d2) converting the Δ chrominance to Δ luminance; and
(d3) calculating the corrected luminance information by summing the separated luminous information with the Δ luminance.

8. The method of claim 5, further comprising:
(d) comparing the current frame with tables in a frame statistics dictionary, wherein the tables comprise statistical values for typical cross color pictures collected during cross color elimination processing of the cross color pictures; and
(e) if the current frame matches any of the tables in the frame statistics dictionary, then enabling cross color detection and adjusting threshold values.

9. A system, comprising:
a frame buffer comprising previous frame pixel colors; and
a dynamic cross color elimination module for receiving separated luminance and chrominance information for each pixel in a current frame from a component video source,
getting absolute distance values between C=a current frame pixel color, P=a previous frame pixel color from the frame buffer, H=a high frequency color of the previous frame, and O=a center of a color space,
comparing each absolute distance value with a predetermined threshold, wherein if any of the absolute distance values exceed the predetermined threshold, then the pixel is a cross color pixel, and
for each cross color pixel, replacing a current frame pixel color with a high frequency average pixel color.

10. The system of claim 9, further comprising:
a Δ chroma module for calculating a Δ chrominance from the separated chrominance information and a cross color corrected chrominance information; and
a Δ luminance encoder for converting the Δ chrominance to a Δ luminance, wherein recovered luminance information is calculated by summing the separate luminance information with the Δ luminance.

11. The system of claim 9, further comprising:
a frame statistics module for collecting statistical values for typical cross color pictures during cross color elimination processing of the cross color pictures;
a frame statistics dictionary comprising tables of the statistical values; and
a comparator for comparing the current frame with the tables in the frame statistics dictionary,
wherein if the current frame matches any of the tables in the frame statistics dictionary, then cross color detection is enabled.

12. A system, comprising:
a first frame buffer comprising a first previous frame pixel colors;
a second frame buffer comprising a second previous frame pixel colors;
a dynamic cross color elimination module for receiving separated luminance and chrominance information for each pixel in the current frame from a component video source,
getting absolute distance values for between C=the current frame pixel color, P1=first previous frame pixel color, and P2=second previous frame pixel color,
getting a sum of the absolute distance values,
comparing each absolute distance value with a first predetermined threshold, and comparing the sum with a second predetermined threshold, wherein if any of the absolute distance values exceed the first predetermined threshold, or the sum exceeds the second predetermined threshold, then the pixel is a cross color pixel, and
for each cross color pixel, replacing a current frame pixel color with a high frequency average pixel color or a same location pixel color of the second previous frame.

13. The system of claim 12, further comprising:
a Δ chroma module for calculating a Δ chrominance from the separated chrominance information and a cross color corrected chrominance information; and
a Δ luminance encoder for converting the Δ chrominance to a Δ luminance, wherein recovered luminance information is calculated by summing the separate luminance information with the Δ luminance.

14. The system of claim 12, further comprising:
a frame statistics module for collecting statistical values for typical cross color pictures during cross color elimination processing of the cross color pictures;
a frame statistics dictionary comprising tables of the statistical values; and
a comparator for comparing the current frame with the tables in the frame statistics dictionary,
wherein if the current frame matches any of the tables in the frame statistics dictionary, then cross color detection is enabled.
